(19) United States
(12) Patent Application Publication
(10) Pub. No.: US 2024/0199188 A1
(43) Pub. Date: Jun. 20, 2024

(54) SUPPORT DEVICE AND SUPPORT METHOD

(71) Applicant: MITSUBISHI HEAVY INDUSTRIES, LTD., Tokyo (JP)

(72) Inventor: Jumpei TANEICHI, Tokyo (JP)

(73) Assignee: MITSUBISHI HEAVY INDUSTRIES, LTD., Tokyo (JP)

(21) Appl. No.: 18/217,887

(22) Filed: Jul. 3, 2023

(30) Foreign Application Priority Data
Dec. 16, 2022 (JP) 2022-201447

(51) Int. Cl. B64C 1/06

(52) U.S. Cl. CPC B64C 1/061; B64C 1/064

(57) ABSTRACT

A support device for supporting a composite material structure that has an elongated shape extending along a longitudinal direction and that is curved along the longitudinal direction includes a plurality of band-like sheets arranged side by side at predetermined intervals along the longitudinal direction, having a band shape extending in an intersecting direction that is a direction intersecting the longitudinal direction, and configured to support the composite material structure from below, and a pair of frames provided for the composite material structure to be interposed therebetween in the intersecting direction, the pair of support portions supporting each of the plurality of band-like sheets. A length of each of the plurality of band-like sheets in the intersecting direction is set to a length corresponding to the curve of the composite material structure.

### CROSS-REFERENCE TO RELATED APPLICATIONS

This application claims the benefit of priority to Japanese Patent Application Number 2022-201447 filed on Dec. 16, 2022. The entire contents of the above-identified application are hereby incorporated by reference.

### TECHNICAL FIELD

The disclosure relates to a support device and a support method.

### RELATED ART

Components used in an aircraft include an elongated component (for example, a stringer) having a predetermined cross-sectional shape (for example, a hat shape) and curved or bent along a longitudinal direction. After molded in a molding device, such a component is conveyed to a curing die for curing and molding and assembled to the curing die. In addition, before or after the assembly, a retaining member which is a member (a core, a bladder, or the like) for retaining the shape during the curing is attached to the component. A known support device supports a component so that the shape of the component does not change in a conveying step or a step of attaching a retaining member (for example, US 2021/0,260,840 A).

US 2021/0.260,840 A discloses a device in which a support portion for supporting a component from below is provided extending over a rectangular recessed portion. According to US 2021/0,260,840 A, a retaining member is attached to the inside of the component that has a hat-shaped cross section and that is supported by the support portion.

### SUMMARY

According to US 2021/0,260,840 A, although consideration is given to supporting the component so that the cross-sectional shape of the component is not deformed when the retaining member is attached, no consideration is given to the shape of the component in the longitudinal direction. Such a device cannot follow the curvature in the longitudinal direction while supporting the component, and thus the component may be deformed (for example, bent) or wrinkles may occur in the component.

The disclosure has been made in view of such circumstances, and an object thereof is to provide a support device and a support method that can make it less likely to cause a situation in which a supported member is deformed or wrinkles occur in the supported member.

In order to solve the problems described above, the support device and the support method of the disclosure adopt the following means.

A support device according to an aspect of the disclosure is a support device for supporting a supported member having an elongated shape extending along a predetermined direction, the supported member being curved or bent along the predetermined direction, the support device including a plurality of band portions arranged side by side at predetermined intervals along the predetermined direction, having a band shape extending in an intersecting direction, and configured to support the supported member from below, the intersecting direction being a direction intersecting the predetermined direction, and a pair of support portions provided for the supported member to be interposed therebetween in the intersecting direction, the pair of support portions supporting each of the plurality of band portions, wherein a length of each of the plurality of band portions in the intersecting direction is set to a length corresponding to the curve or the bend of the supported member.

A support method according to an aspect of the disclosure is a support method for supporting a supported member having an elongated shape extending along a predetermined direction, the supported member being curved or bent along the predetermined direction, the support method including supporting the supported member by a plurality of band portions, wherein a length of each of the plurality of band portions is set by a support device to a length corresponding to the curve of the supported member, the support device including the plurality of band portions, the plurality of band portions being arranged side by side at predetermined intervals along the predetermined direction, having a band shape extending in an intersecting direction, and configured to support the supported member from below, the intersecting direction being a direction intersecting the predetermined direction, and a pair of support portions provided for the supported member to be interposed therebetween in the intersecting direction, the pair of support portions supporting each of the plurality of band portions.

The disclosure can make it less likely to cause a situation in which the supported member is deformed or wrinkles occur in the supported member.

### BRIEF DESCRIPTION OF DRAWINGS

The disclosure will be described with reference to the accompanying drawings, wherein like numbers reference like elements.

FIG. 1 is a perspective view illustrating a support device according to the disclosure.

FIG. 2 is a vertical cross-sectional view illustrating the support device according to the disclosure.

FIG. 3 is a side view illustrating the support device according to the disclosure.

FIG. 4 is a flowchart illustrating a method for manufacturing a composite material structure according to the disclosure.

FIGS. 5A to 5C are vertical cross-sectional views illustrating the support device according to the disclosure. FIG. 5A illustrates a case where the length of a band portion is shorter than that in a neutral state, FIG. 5B illustrates a case where the length of the band portion is equal to that in the neutral state, and FIG. 5C illustrates a case where the length of the band portion is longer than that in the neutral state.

FIG. 6 is a vertical cross-sectional view illustrating the composite material structure and a core according to the disclosure.

FIG. 7 is a vertical cross-sectional view illustrating the support device and a curing die according to the disclosure.

FIG. 8 is a vertical cross-sectional view illustrating the support device and the curing die according to the disclosure.

FIG. 9 is a vertical cross-sectional view illustrating the support device and the curing die according to the disclosure.

FIG. 10 is a vertical cross-sectional view illustrating the support device and the curing die according to the disclosure.

### DESCRIPTION OF EMBODIMENTS

An embodiment of a support device and a support method according to the disclosure will be described below with reference to the drawings.

The support device according to the present embodiment is used when a composite material structure is manufactured from a plate-like laminate formed by laminating fiber sheets impregnated with resin such as prepreg. Examples of the composite material structure include a stringer used for a fuselage, a main wing, or the like of an aircraft. Note that the material for forming the laminate is not limited to the above material. For example, the laminate may be formed of a fiber sheet (dry sheet) containing only fibers and no resin.

In the following description, a direction simply referred to as a “longitudinal direction” or a “widthwise direction” means the longitudinal direction or the widthwise direction of the composite material structure.

### Composite Material Structure

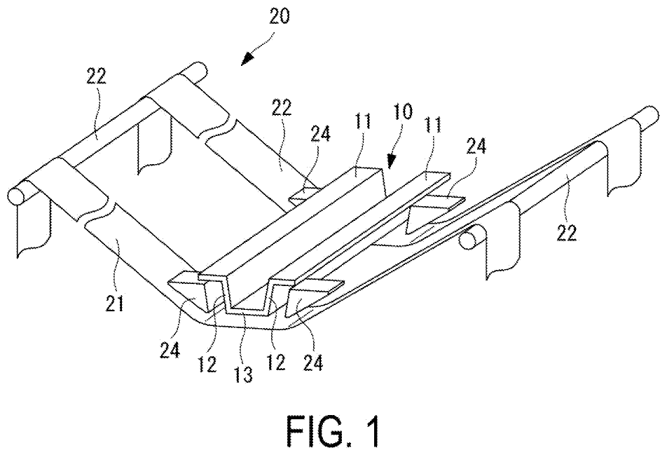

As illustrated in FIG. 1, a composite material structure (supported member) 10 according to the present embodiment is an elongated member extending in the longitudinal direction, and a cross section in the longitudinal direction (a cross section taken along a plane orthogonal to the longitudinal direction) has a so-called hat shape. The composite material structure 10 has a uniform cross-sectional shape in the longitudinal direction over the entire region in the longitudinal direction. The length of the composite material structure 10 in the longitudinal direction is, for example, about 15 m or more and 20 m or less.

The composite material structure 10 integrally includes a pair of flange portions 11 disposed at both ends in the widthwise direction and extending in the widthwise direction, a pair of web portions 12 extending obliquely inward from inner end portions of the flange portions 11 in the width wise direction, and a cap portion 13 coupling inner end portions of the pair of web portions 12 to each other. That is, the cross-sectional shape of the composite material structure 10 in the longitudinal direction also includes the flange portions 11, the web portions 12, and the cap portion 13.

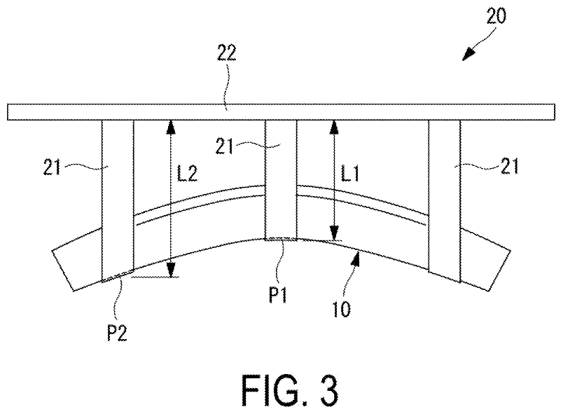

As illustrated in FIG. 3, the composite material structure 10 is curved along the longitudinal direction. That is, a cross section in the widthwise direction (a cross section taken along a plane orthogonal to the widthwise direction) also has a predetermined cross-sectional shape. Note that, in FIG. 1, for the sake of illustration, the composite material structure 10 is not illustrated 5 as curved along the longitudinal direction of the composite material structure and is illustrated linearly.

### Support Device

Next, a support device 20 will be described below with reference to FIGS. 1 to 3. The support device 20 is a device used when the composite material structure 10 before being molded into a predetermined shape and cured is stored and conveyed.

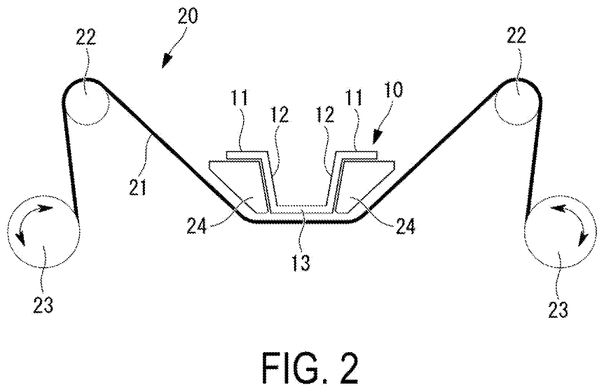

As illustrated in FIGS. 1 and 2, the support device 20 supports the composite material structure 10 with the cap portion 13 positioned at a lower portion. Moreover, as illustrated in FIG. 3, the support device 20 supports the composite material structure 10 with the curved portion of the composite material structure 10 protruding upward.

As illustrated in FIGS. 1 and 2, the support device 20 includes a 20 plurality of band-like sheets (band portions) 21 arranged side by side at predetermined intervals along the longitudinal direction, a pair of frames (support portions) 22 provided with the composite material structure 10 interposed therebetween in the widthwise direction and supporting the band-like sheets 21, reels (adjustment portions) 23 adjusting the lengths of the band-like sheets 21, and a plurality of cushions (buffer portions) 24 provided 25 between the band-like sheets 21 and the composite material structure 10.

Each band-like sheet 21 extends in the widthwise direction. The band-like sheet 21 is deformed by the weight of the composite material structure 10. The band-like sheet 21 is formed of a material that is flexible, hard to stretch, and hard to break. The band-like sheet 21 is formed of, for example, a material obtained by applying fluorine coating to a glass fiber fabric. The composite material structure 10 is placed on the band-like sheet 21.

The band-like sheet 21 is placed on the upper surfaces of the pair of frames 22 arranged side by side along the widthwise direction. Both end portions of the band-like sheet 21 are fixed to the reels 23 disposed below the frames 22. The length of the band-like sheet 21 (to be exact, the length of a portion of the band-like sheet 21 not wound around the reels 23) can be changed by feeding and winding the band-like sheet 21 by the reels 23. In a state where the composite material structure 10 is placed, the band-like sheet 21 extends obliquely upward from the placement portion toward each frame 22, and the extending direction of the band-like sheet 21 is changed downward by the frame 22. The band-like sheet 21 folded downward by the frame 22 extends substantially vertically downward, and the end portion is fixed to the reel 23.

The band-like sheet 21 has a width of, for example, about 50 mm to 60 mm. As illustrated in FIGS. 1 and 3, the plurality of band-like sheets 21 are arranged side by side at regular intervals. The interval between the adjacent band-like sheets 21 is determined based on the rigidity and the like of the composite material structure 10. The interval between the adjacent band-like sheets 21 is, for example, about 500 mm to 600 mm.

Further, as illustrated in FIG. 3, the composite material structure 10 is curved along the longitudinal direction, and thus different portions in the longitudinal direction are located at different height positions.

In the present embodiment, the band-like sheets 21 arranged side by side in the longitudinal direction each have a length corresponding to the curvature of the composite material structure 10. Specifically, a length L1 of the band-like sheet 21 that supports a portion (referred to as a “first portion P1”) at a high height position in the composite material structure 10 is shorter than a length L2 of the band-like sheet 21 that supports a portion (referred to as a “second portion P2”) at a lower height position than the first portion P1. The lengths L1 and L2 of the band-like sheets 21 illustrated in FIG. 3 are the lengths of the band-like sheets 21 when the composite material structure 10 is viewed from the horizontal direction. The length of the band-like sheet 21 when the composite material structure 10 is viewed from the horizontal direction changes in accordance with the length of the band-like sheet 21 present between the pair of frames 22. That is, when the length of the band-like sheet 21 present between the pair of frames 22 increases, the length of the band-like sheet 21 when the composite material structure 10 is viewed from the horizontal direction also increases. On the other hand, when the length of the band-like sheet 21 present between the pair of frames 22 decreases, the length of the band-like sheet 21 when the composite material structure 10 is viewed from the horizontal direction also decreases.

Each frame 22 is a cylindrical member extending along the longitudinal direction. The frame 22 extends along the horizontal direction. The pair of frames 22 are provided with the composite material structure 10 interposed therebetween in the widthwise direction. The band-like sheet 21 is suspended by the frames 22.

As illustrated in FIG. 2, each reel 23 rotates about a central axis extending along the longitudinal direction. The reels 23 rotate to feed and wind the band-like sheet 21. The length of the band-like sheet 21 (specifically, the length of the band-like sheet 21 positioned between the pair of frames 22) is adjusted by feeding and winding the band-like sheet 21 by the reels 23. The two reels 23 are provided per one band-like sheet 21. The end portion of the band-like sheet 21 is fixed to each reel 23.

The adjustment of the length of the band-like sheet 21 by the reels 23 may be performed manually or by a controller.

The controller include, for example, a central processing unit (CPU) (processor), a main memory, and a secondary storage (memory). Further, the controller may include a communication unit for transmitting and receiving information to and from another device.

The main memory includes a writable memory such as a cache memory and a random access memory (RAM) and is used as a work area for reading an execution program of the CPU and writing processing data by the execution program, for example.

The secondary storage is a non-transitory computer-readable storage medium. Examples of the secondary storage include a magnetic disk, a magneto-optical disk, a CD-ROM, a DVD-ROM, and a semiconductor memory.

A series of processing operations for implementing various functions is, for example, stored in the secondary storage in the form of a program, and the CPU reads the program into the main memory and executes information processing and computation processing, thereby implementing various functions. The program may be a program pre-installed in the secondary storage, a program provided in a state of being stored in a computer-readable storage medium, a program distributed through wired or wireless communication means, or the like. The computer-readable storage medium includes a magnetic disk, a magneto-optical disk, a CD-ROM, a DVD-ROM, and a semiconductor memory.

As illustrated in FIG. 2, each cushion 24 is provided between the web portion 12 and the flange portion 11 of the composite material structure 10 and the band-like sheet 21. The cushion 24 suppresses deformation of the composite material structure 10. Specifically, the cushion 24 prevents the flange portion 11 and the band-like sheet 21 from coming into contact with each other, thereby suppressing deformation of the flange portion 11. Further, the angle formed by the web portion 12 and the cap portion 13 is made unchanged.

The cushion 24 is formed of a member having a certain degree of rigidity (for example, wood, polystyrene foam, or plastic). The material of the cushion 24 is desirably lightweight.

A cross section of the cushion 24 in the longitudinal direction has a substantially triangular shape. The surface of the cushion 24 in contact with the composite material structure 10 has a shape corresponding to the shape of the composite material structure 10. The surface of the cushion 24 in contact with the band-like sheet 21 is inclined at a predetermined angle with respect to the horizontal plane. The predetermined angle is an angle at which an excessive load is not applied from the band-like sheet 21 to the composite material structure 10.

The cushions 24 are provided on both sides of the composite material structure 10 in the widthwise direction. The plurality of cushions 24 are provided along the longitudinal direction. The cushions 24 are provided corresponding to all the band-like sheets 21. The length of the cushion 24 in the longitudinal direction is longer than the width of the band-like sheet 21.

### Support Method

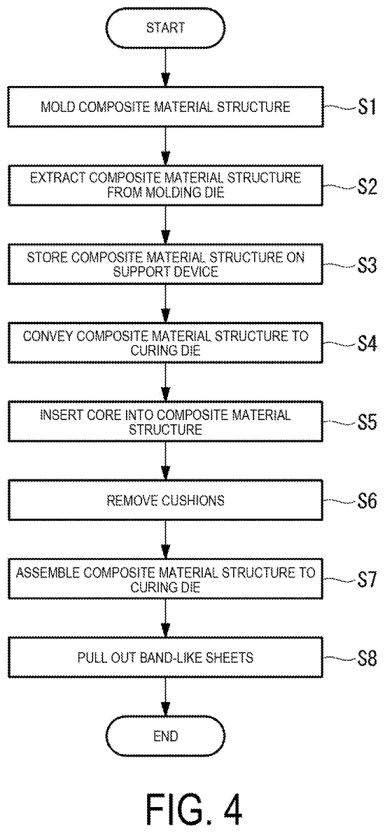

Next, the support method and the behavior of the support device will be described with reference to FIGS. 4 to 10.

As illustrated in a flowchart of FIG. 4, a laminate having a flat plate shape is first pressed by a molding die (not illustrated) and thus molded into a desired shape (step S1). In the present embodiment, the composite material structure 10 is formed to have a hat-shaped cross section in the longitudinal direction and to be curved along the longitudinal direction. At this time, the band-like sheets 21 are laid at predetermined positions in the molding die, and the cushions 24 are placed at predetermined positions on the band-like sheets 21. After molding, the molding die is opened and the band-like sheets 21 are lifted up, so that the composite material structure 10 is extracted from the molding die (step S2). This allows the composite material structure 10 to be released from the molding die and also supported by the support device 20. When the cushions 24 are disposed in the molding die in this way, recessed portions having shapes corresponding to the cushions 24 are formed at positions of the molding die where the cushions 24 are provided.

Note that the above description is a mere example, and the disclosure is not limited thereto. For example, the composite material structure 10 may be molded without provision of the band-like sheets 21 and the cushions 24 in the molding die, the composite material structure 10 that has been taken out from the molding die may be placed on the band-like sheets 21, and the cushions 24 may be provided at predetermined positions between the band-like sheets 21 and the composite material structure 10.

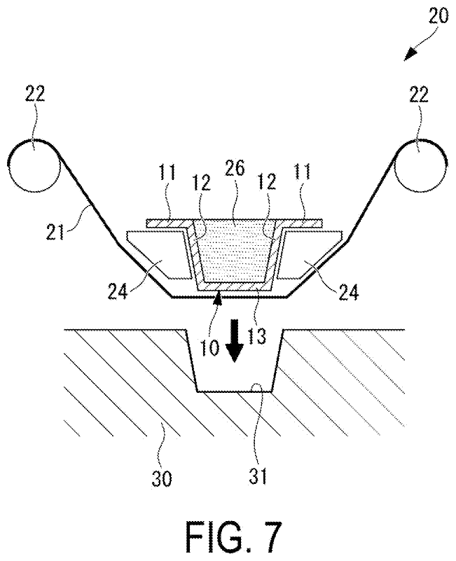

Next, the composite material structure 10 is extracted from the molding die and stored in a state of being supported by the support device 20 (step S3). Next, the composite material structure 10 is conveyed to a curing die 30 (see FIG. 7) (step S4).

Next, a core 26 is inserted into a recessed portion (a space defined by the pair of web portions 12 and the cap portion 13) of the composite material structure 10 that opens upward (step S5). At this time, the length of each band-like sheet 21 is decreased by winding the band-like sheet 21 by the reels 23.

The support device 20 can expand or reduce the shape of the recessed portion of the composite material structure 10 by adjusting the length of the band-like sheet 21.

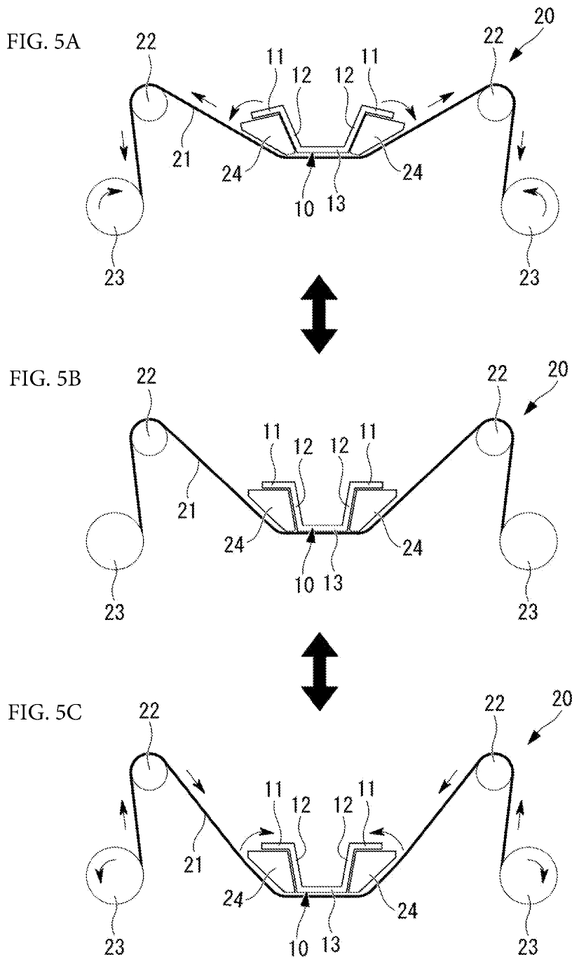

Specifically, when the band-like sheet 21 is wound by the reels 23 from the neutral state (see FIG. 5B) and the length of the band-like sheet 21 is decreased, the support device 20 can widen the recessed portion of the composite material structure 10 as illustrated in FIG. 5A. This is because deformation (bending) of the band-like sheet 21 is reduced when the band-like sheet 21 is short (that is, when the length of the band-like sheet 21 present between the pair of frames 22 is short). As a result, when the band-like sheet 21 supports the composite material structure 10, the side portion of the composite material structure 10 and the band-like sheet 21 do not come into contact with each other, or even when they come into contact with each other, a load laterally applied from the band-like sheet 21 to the side portion of the composite material structure 10 is small. As a result, the composite material structure 10 is easily deformed laterally. Thus, the opening of the recessed portion of the composite material structure 10 is easily opened.

On the other hand, when the band-like sheet 21 is fed by the reels 23 from the neutral state (see FIG. 5B) and the length of the band-like sheet 21 is increased, a load can be applied in a direction in which the recessed portion of the composite material structure 10 is narrowed as illustrated in FIG. 5C. This is because deformation (bending) of the band-like sheet 21 is enlarged when the band-like sheet 21 is long (that is, when the length of the band-like sheet 21 present between the pair of frames 22 is long). As a result, when the band-like sheet 21 supports the composite material structure 10, a load laterally applied from the band-like sheet 21 to the side portion of the composite material structure 10 is large. Thus, the opening of the recessed portion of the composite material structure 10 is less likely to open and easy to close.

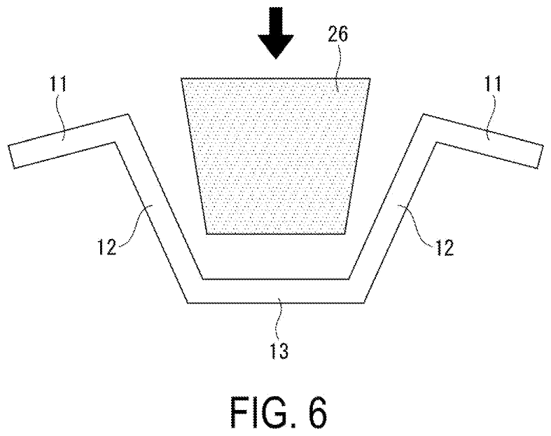

In this way, winding the band-like sheet 21 by the reels 23 in step S5 decreases the length of the band-like sheet 21 and facilitates the opening of the recessed portion. In this state, as illustrated in FIG. 6, the core (retaining member) 26 is inserted into the recessed portion of the composite material structure 10. The core 26 is a member for suppressing deformation of the composite material structure 10 during the curing.

Next, as illustrated in FIG. 7, the support device 20 conveys the composite material structure 10 to the vicinity of a recessed portion 31 of the curing die 30. The curing die 30 is a device for curing the assembled composite material structure 10. The recessed portion 31 has a shape corresponding to the composite material structure 10, and the composite material structure 10 is assembled to the recessed portion 31.

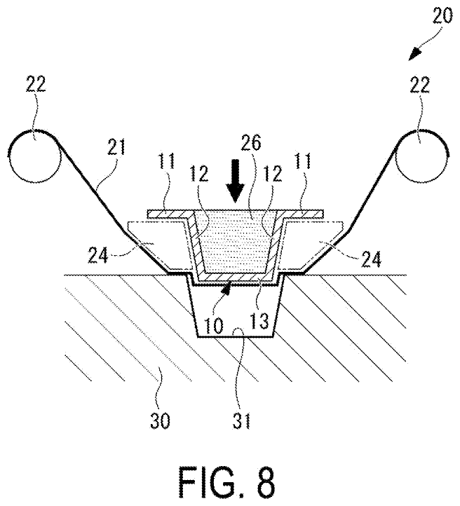

Next, as illustrated in FIG. 8, all of the cushions 24 are removed (step S6). At this time, the cushions 24 may be removed in a state where only the lower end of the composite material structure 10 is inserted into the recessed portion 31.

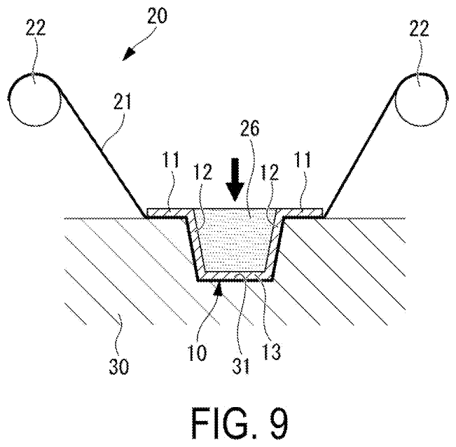

Next, as illustrated in FIG. 9, the composite material structure 10 is inserted into the recessed portion 31, and the composite material structure 10 is assembled to the curing die 30 (step S7). At this time, the band-like sheets 21 are not yet removed.

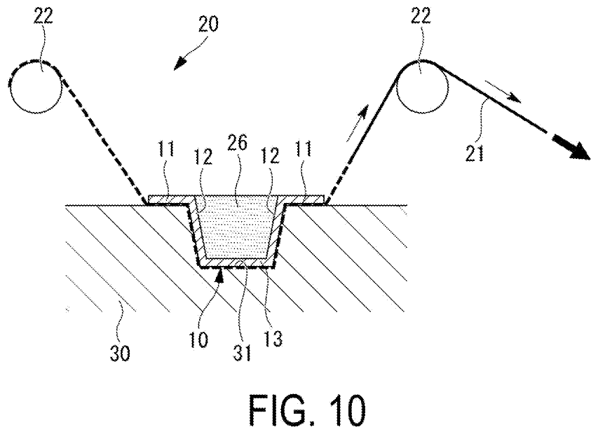

Next, as illustrated in FIG. 10, the band-like sheets 21 are pulled from one side in the widthwise direction and thus pulled out from between the curing die 30 and the composite material structure 10 (step S8).

In this way, the composite material structure 10 is supported by the support device 20 and assembled to the curing die 30.

According to the present embodiment, the following operational effects are obtained.

In the present embodiment, the plurality of band-like sheets 21 have lengths corresponding to the curvature of the composite material structure 10. This makes uniform a load applied to the composite material structure 10 in the longitudinal direction. Thus, it is possible to suppress concentration of the load on a local area, which makes it less likely for the composite material structure 10 to deform. In addition, wrinkles (for example, wrinkles due to bending) are less likely to occur in the composite material structure 10.

Further, in the present embodiment, the composite material structure 10 is supported from below by the band-like sheets 21, and the band-like sheets 21 are supported by the pair of frames 22. That is, the band-like sheets 21 are disposed extending between the pair of frames 22. Thus, the band-like sheets 21 are relatively easily deformed. Thus, since the band-like sheets 21 are deformed corresponding to the shape of the mold, the composite material structure 10 can be assembled into the curing die 30 in a state where the band-like sheets 21 support the composite material structure 10. This can facilitate assembling to the composite material structure 10. In addition, since the composite material structure 10 can be assembled to the mold while being supported, the shape of the composite material structure 10 can be easily maintained appropriately.

In the present embodiment, each cushion 24 having a shape corresponding to the shape of the frame 22 is provided between the band-like sheet 21 and the composite material structure 10. As a result, the cushion 24 receives a load applied from the band-like sheet 21, so that the shape of the composite material structure 10 can be appropriately maintained.

In the present embodiment, the reels 23 for adjusting the length of each band-like sheet 21 in the intersecting direction are provided. Thus, the length of each band-like sheet 21 can be adjusted to a desired length. Thus, even when the composite material structure 10 is curved or bent in any manner in the longitudinal direction, a load applied to the composite material structure 10 in the longitudinal direction can be made uniform by adjusting the length of the band-like sheet 21. Thus, it is possible to suppress concentration of the load on a local area, which makes it less likely for the composite material structure 10 to deform. This can also make it less likely for wrinkles to occur in the composite material structure 10.

In some cases, for prevention of the composite material structure 10 from being deformed during the curing, the core 26 is inserted into the recessed portion (the space defined by the pair of web portions 12 and the cap portion 13) of the composite material structure 10 that opens upward. The core 26 has a shape corresponding to the shape of the recessed portion (that is, the core 26 is inserted to be fitted into the recessed portion). Thus, if the core 26 is inserted into the recessed portion as it is, the core 26 is pushed therein while coming into contact with the wall surface of the recessed portion. In such a case, friction between the wall surface of the recessed portion and the core 26 may cause a problem in which wrinkles occur in the recessed portion (i.e., the composite material structure 10), the core 26 is deformed, or the core 26 is caught on the wall surface of the recessed portion during the insertion and improperly inserted.

On the other hand, in the present embodiment, the composite material structure 10 is supported from below by the band-like sheets 21, and the band-like sheets 21 are supported by the pair of frames 22. That is, the band-like sheets 21 are disposed extending between the pair of frames 22. As a result, the band-like sheets 21 are deformed to be bent downward by the weight of the composite material structure 10 placed on the band-like sheets 21. In detail, the slackened band-like sheets 21 are stretched by the weight of the composite material structure 10. At this time, the degree of deformation (bending) of each band-like sheet 21 changes in accordance with the length of the band-like sheet 21 (the length of the band-like sheet 21 present between the pair of frames 22). That is, when the band-like sheet 21 is short, the deformation (bending) of the band-like sheet 21 is relatively small. On the other hand, when the band-like sheet 21 is long, the deformation (bending) of the band-like sheet 21 is relatively large.

In a case where the deformation (bending) of the band-like sheet 21 is small, when the band-like sheet 21 supports the composite material structure 10, the side portion of the composite material structure 10 and the band-like sheet 21 do not come into contact with each other, or even when they come into contact with each other, a load laterally applied from the band-like sheet 21 to the side portion of the composite material structure 10 is small. As a result, the composite material structure 10 is easily deformed laterally. Thus, the opening of the recessed portion of the composite material structure 10 is easily opened.

On the other hand, in a case where the deformation (bending) of the band-like sheet 21 is large, when the band-like sheet 21 supports the composite material structure 10, a load laterally applied from the band-like sheet 21 to the side portion of the composite material structure 10 is large. Accordingly, the composite material structure 10 is less likely to deform laterally. Thus, the opening of the recessed portion of the composite material structure 10 is less likely to open.

The present embodiment includes inserting the core 26 into the recessed portion of the composite material structure 10 after decreasing the lengths of the band-like sheets 21 in the intersecting direction. Accordingly, the core 26 can be inserted into the recessed portion in a state in which the opening of the recessed portion of the composite material structure 10 is easily opened. Thus, friction between the wall surface of the recessed portion and the core 26 can be reduced. Thus, the core 26 can be easily inserted. In addition, in the inserting of the core 26, it is possible to make it less likely to cause a situation in which wrinkles occur in the composite material structure 10, the core 26 is deformed, or the core 26 comes into contact with the wall surface of the recessed portion during the insertion.

Note that the disclosure is not limited to the above-described embodiments and can be modified as required without departing from the spirit of the disclosure.

For example, although the example in which the support device 20 supports the composite material structure 10 with the curved portion of the composite material structure 10 protruding upward has been described in the above-described embodiment, the disclosure is not limited thereto. For example, the support device 20 may support the composite material structure 10 with the curved portion of the composite material structure 10 protruding downward.

Although the example in which the cross-sectional shape of the composite material structure 10 in the longitudinal direction is a hat shape has been described in the above-described embodiment, the disclosure is not limited thereto. The cross-sectional shape of the composite material structure 10 in the longitudinal direction may be a shape other than the hat shape. For example, the cross-sectional shape of the composite material structure 10 may include only the web portions 12 and the cap portion 13 without including the flange portions 11.

In addition, although the example in which the composite material structure 10 is curved along the longitudinal direction has been described in the above-described embodiment, the composite material structure 10 may be bent partially in the longitudinal direction.

Although the example in which the plurality of cushions 24 are provided along the longitudinal direction has been described in the above-described embodiment, the disclosure is not limited thereto. The cushions may extend along the longitudinal direction and be in contact with substantially the entire longitudinal region of the composite material structure 10.

The mechanism for adjusting the length of each band-like sheets 21 is not limited to the reels 23. For example, the length of the band-like sheet 21 may be adjusted by a slider or the like.

The support device and the support method described in the above-described embodiments can be understood, for example, as follows.

A support device according to a first aspect of the disclosure is a support device (20) for supporting a supported member (10) having an elongated shape extending along a predetermined direction, the supported member being curved or bent along the predetermined direction, the support device including a plurality of band portions (21) arranged side by side at predetermined intervals along the predetermined direction, having a band shape extending in an intersecting direction, and configured to support the supported member from below, the intersecting direction being a direction intersecting the predetermined direction, and a pair of support portions (22) provided for the supported member to be interposed therebetween in the intersecting direction, the pair of support portions supporting each of the plurality of band portions, wherein a length of each of the plurality of band portions in the intersecting direction is set to a length corresponding to the curve or the bend of the supported member.

In the configuration described above, the plurality of band portions have lengths corresponding to the curvature of the supported member. This can make uniform a load applied to the supported member in the predetermined direction. Thus, it is possible to suppress concentration of the load on a local area, which makes it less likely for the supported member to deform. This can also make it less likely for wrinkles to occur in the supported member.

Further, in the above configuration, the supported member is supported from below by the band portions, and the band portions are supported by the pair of support portions. That is, the band portions are disposed extending between the pair of support portions. Accordingly, the band portions are relatively easily deformed. Thus, since the band portions are deformed corresponding to the shape of the mold, it is possible to assemble the supported member into the mold (for example, a curing die for curing the supported member) in a state where the band portions support the supported member. Thus, it is possible to facilitate the assembling to the supported member. In addition, since the supported member can be assembled to the mold while being supported, the shape of the supported member can be easily maintained appropriately.

In addition, a support device according to a second aspect of the disclosure is the support device according to the first aspect, further including a buffer portion (24) provided between each of the plurality of band portions and the supported member and having a shape corresponding to a shape of the supported member.

In the above configuration, the buffer portion having a shape corresponding to the shape of the supported member is provided between the band portion and the supported member. As a result, the buffer portion receives a load applied from the band portion, and thus the shape of the supported member can be appropriately maintained.

In addition, a support device according to a third aspect of the disclosure is the support device according to the first or second aspect, further including an adjustment portion (23) configured to adjust the length of each of the plurality of band portions in the intersecting direction.

In the above-described configuration, the adjustment portion configured to adjust the length of each band portion in the intersecting direction is provided. This enables adjustment of the length of each band portion to a desired length. Thus, even when the supported member is curved or bent in any manner in the longitudinal direction, a load applied to the supported member in the predetermined direction can be made uniform by adjusting the length of the band portion. Thus, it is possible to suppress concentration of the load on a local area, which makes it less likely for the supported member to deform. This can also make it less likely for wrinkles to occur in the supported member.

A support method according to a fourth aspect of the disclosure is a support method for supporting a supported member (10) having an elongated shape extending along a predetermined direction, the supported member being curved or bent along the predetermined direction, the support method including supporting the supported member by a plurality of band portions (21), wherein a length of each of the plurality of band portions is set by a support device to a length corresponding to the curve of the supported member, the support device including the plurality of band portions, the plurality of band portions being arranged side by side at predetermined intervals along the predetermined direction, having a band shape extending in an intersecting direction, and configured to support the supported member from below, the intersecting direction being a direction intersecting the predetermined direction, and a pair of support portions (24) provided for the supported member to be interposed therebetween in the intersecting direction, the pair of support portions supporting each of the plurality of band portions.

In addition, a support method according to a fifth aspect of the disclosure is the support method according to the fourth aspect, wherein the supported member includes a recessed portion opening upward, and the support method further includes inserting a retaining member (26), configured to retain a shape of the supported member, into the recessed portion of the supported member after decreasing the length of each of the plurality of band portions in the intersecting direction.

In the above configuration, the supported member is supported from below by the band portions, and the band portions are supported by the pair of support portions. That is, the band portions are disposed extending between the pair of support portions. Accordingly, the band portions are deformed to be bent downward by the weight of the supported member placed on the band portions. In detail, the slackened band portions are stretched by the weight of the supported member. At this time, the degree of deformation (bending) of each band portion changes in accordance with the length of the band portion (the length of the band portion present between the pair of support portions). That is, when the band portion is short, the deformation (bending) of the band portion is relatively small. On the other hand, when the band portion is long, the deformation (bending) of the band portion is relatively large.

In a case where the deformation (bending) of the band portion is small, when the band portion supports the supported member, the side portion of the supported member and the band portion do not come into contact with each other, or even when they come into contact with each other, a load laterally applied from the band portion to the side portion of the supported member is small. Thus, the supported member is easily deformed laterally. Thus, the opening of the recessed portion of the supported member is easily opened.

On the other hand, in a case where the deformation (bending) of the band portion is large, when the band portion supports the supported member, a load laterally applied from the band portion to the side portion of the supported member is large. Thus, the supported member is less likely to deform laterally. Thus, the opening of the recessed portion of the supported member is less likely to open.

In the above-described configuration, the method includes inserting the retaining member into the recessed portion of the member after decreasing the length of each of the band portions in the intersecting direction. Accordingly, it is possible to insert the retaining member into the recessed portion in a state where the opening of the recessed portion of the supported member is easily opened. Thus, it is possible to reduce friction between the wall surface of the recessed portion and the retaining member. Thus, the retaining member can be easily inserted. In addition, in the inserting of the retaining member, it is possible to make it less likely to cause a situation in which wrinkles occur in the supported member, the retaining member is deformed, or the retaining member is caught on the wall surface of the recessed portion during the insertion.

While preferred embodiments of the invention have been described as above, it is to be understood that variations and modifications will be apparent to those skilled in the art without departing from the scope and spirit of the invention. The scope of the invention, therefore, is to be determined solely by the following claims.

1. A support device for supporting a supported member having an elongated shape extending along a predetermined direction, the supported member being curved or bent along the predetermined direction, the support device comprising:
a plurality of band portions arranged side by side at predetermined intervals along the predetermined direction, having a band shape extending in an intersecting direction, and configured to support the supported member from below, the intersecting direction being a direction intersecting the predetermined direction; and
a pair of support portions provided for the supported member to be interposed therebetween in the intersecting direction, the pair of support portions supporting each of the plurality of band portions, wherein
a length of each of the plurality of band portions in the intersecting direction is set to a length corresponding to the curve or the bend of the supported member.

2. The support device according to claim 1, further comprising
a buffer portion provided between each of the plurality of band portions and the supported member and having a shape corresponding to a shape of the supported member.

3. The support device according to claim 1, further comprising
an adjustment portion configured to adjust the length of each of the plurality of band portions in the intersecting direction.

4. A support method for supporting a supported member having an elongated shape extending along a predetermined direction, the supported member being curved or bent along the predetermined direction, the support method comprising
supporting the supported member by a plurality of band portions, wherein
a length of each of the plurality of band portions is set by a support device to a length corresponding to the curve of the supported member, the support device including
the plurality of band portions, the plurality of band portions being arranged side by side at predetermined intervals along the predetermined direction, having a band shape extending in an intersecting direction, and configured to support the supported member from below, the intersecting direction being a direction intersecting the predetermined direction, and
a pair of support portions provided for the supported member to be interposed therebetween in the intersecting direction, the pair of support portions supporting each of the plurality of band portions.

5. The support method according to claim 4, wherein
the supported member includes a recessed portion opening upward, and
the support method further includes inserting a retaining member, configured to retain a shape of the supported member, into the recessed portion of the supported member after decreasing the length of each of the plurality of band portions in the intersecting direction.
